(19) United States
(12) Patent Application Publication
(10) Pub. No.: US 2019/0226909 A1
(43) Pub. Date: Jul. 25, 2019

(54) METHOD AND DEVICE FOR SPATIALLY RESOLVED MEASUREMENT OF RADIATION SIGNALS

(71) Applicants: UNIVERSITÄT STUTTGART, STUTTGART (DE); EBERHARD-KARLS UNIVERSITÄT TÜBINGEN, TUBINGEN (DE)

(72) Inventors: Marcel BERNER, HOLZGERLINGEN (DE); Sascha KOCH, STUTTGART (DE); Urs HILBIG, TÜBINGEN (DE); Markus SCHUBERT, TÜBINGEN (DE); Günter GAUGLITZ, TÜBINGEN (DE)

(21) Appl. No.: 16/257,471

(22) Filed: Jan. 25, 2019

Related U.S. Application Data
(63) Continuation of application No. PCT/EP2017/068153, filed on Jul. 18, 2017.

(30) Foreign Application Priority Data
Jul. 26, 2016 (DE) 10 2016 113 703.0

(51) Int. Cl. G01J 1/04; G01J 1/44; G01J 3/02; G01J 1/42; G01J 3/45

(52) U.S. Cl. CPC G01J 1/0437; G01J 1/44; G01J 2001/4242; G01J 1/4228; G01J 3/45; G01J 3/0229

(57) ABSTRACT

A measuring method and a measuring device for the spatially resolved measurement of radiation signals, in particular light signals, wherein RIfS-measurements can be carried out. At least two locations are imaged onto a detector in a spatially resolved manner by means of a spatial modulator, and either by means of a Hadamard transformation the intensity difference is calculated between the two locations from the detected signal by modulating the locations using the same Hadamard sequence, wherein one of the Hadamard sequences at one location is inverted compared to the other sequence at the respective other location, or the intensity difference between the two locations is calculated from the signal detected from the two locations with the same frequency by means of a Fourier transformation, wherein the signals are amplitude-modulated, but phase-shifted relative to one another.

### CROSS-REFERENCES TO RELATED APPLICATIONS

This application is a continuation of international patent application PCT/EP2017/068153, filed on Jul. 18, 2017 designating the U.S., which international patent application has been published in German language and claims priority from German patent application 10 2016 113 703.0, filed on Jul. 26, 2016. The entire contents of these priority applications are incorporated herein by reference.

### BACKGROUND OF THE INVENTION

The invention relates to a measuring method and a measuring device for the spatially resolved measurement of radiation signals, in particular light signals, in particular for the reflectometric interference spectroscopy (RIfS). The invention further relates to a device for measuring spatially resolved radiation signals, in particular light signals, in particular for the reflectometric interference spectroscopy (RIfS).

The reflectometric interference spectroscopy (Reflectrometric Interference Spectroscopy) is a measuring method from the bioanalytic for a marker-free time-resolved observation of layer thickness variations. According to Günther Gauglitz et al., “Strategies for label-free optical detection”, Adv Biochem Engin/Biotechnol (2008) 109:395-432 RIfS is based on a variation of the layer thickness or of the refractive index at the superposition of the partial rays at thin interfaces during reflection at the outer surface and at the inner interface. As soon as the impinging light has left the layers, there are constructive and destructive interferences. These effect a characteristic modulation of the reflectance. Variations in the layer thickness lead to a variation of the minimum or the maximum of this curve (A. Brecht, G. Gauglitz/Analytica Chimica Acta 347 (1997) 219-233). RIfS can be performed using white light with a diode array spectrometer for observation. In addition monochromatic setups are in use that operate with high-resolution camera systems to allow a simultaneous investigation of a larger observation surface.

Such RIfS systems suffer from the drawback posed by the high effort that comes with the detector systems, in particular CCD cameras that must have a high sensitivity. A particular disadvantage rests in the fact that the intensity variations which are based on the variations of the layer thicknesses are only very small when compared to the total signal. Due to the high basic brightness the measuring signal only makes a fraction of the detected signal. If the detector has an insufficient dynamic resolution, then the measuring signal cannot be resolved any more from the total signal.

In addition it is basically known in the prior art to insert into the light path between the observation object and the sensor spatial modulators (Spatial Light Modulator, SLMs) that modulate the observed brightnesses spatially resolved. By means of digital light modulators, such as with mechanically moved perforated discs or light shade strips, a modulation sequence can be assigned to the observation positions by a so-called Hadamard transformation. The Hadamard transformation is a digital transformation. A sensor now captures all modulated Hadamard partial signals of the different locations. The respective mathematical back-transformation, applied to the total signal values captured at the sensor that are recorded in discrete time steps now allows the computation of the brightness values at the modulated locations. Such a single-sensor camera is known as a Hadamard Imager (Swift, R. D. et al. (1976), “Hadamard Transform Imager and Imaging Spectrometer”, Applied Optics, 15(6), 1595-1609). Such a digital spatial light modulation is also possible with micro mirror arrays, DMAs or with reflective or transmissive LCDs-modulators. Hadamard imagers due to the relatively complicated structure usually are only used in special situations, such as in the satellite technique. A Hadamard spectrometer is described in U.S. Pat. No. 6,208,413.

### SUMMARY OF THE INVENTION

In view of this it is a first aspect of the invention to disclose a measuring method and a device for the spatially resolved measurement of radiation signals, in particular of light signals, that in particular are suitable for a reflectometric interference spectroscopic measurement and that allow for a high dynamic at low cost.

It is another aspect of the invention to disclose a measuring method and a device for the spatially resolved measurement of radiation signals having a selective high dynamic in view of a high background signal.

It is still another aspect of the invention to disclose a measuring method and a device for the spatially resolved measurement of radiation signals allowing to observe N spots and to detect a brightness change between the spots, that in particular, is suitable for a star monitoring of exo planets using the transit method.

According to one aspect a device for measuring spatially resolved radiation signals is disclosed, the device comprising:

a spatial modulator configured for a spatially resolved imaging of a plurality of pairs of locations onto a detector, said detector being arranged for receiving a signal from said imaging of said plurality of pairs of locations;

a computer being configured for either controlling said spatial modulator for imaging each pair of locations onto said detector by means of the same Hadamard sequency, wherein said Hadamard sequency is inverted at one location of said pair with respect to another location of said pair, and a signal received by said detector is evaluated by means of a Hadamard transformation for computing an intensity difference between said pair of locations; or

wherein said computer is configured for controlling said spatial modulator for imaging each pair of locations onto said detector by means of an amplitude modulating of both locations of a pair with the same frequency, however with a phase-shifting of 180°, and is configured for evaluating a signal received by said detector for computing an intensity difference between said locations of said pair using a Fourier transformation.

According to another aspect a device for measuring spatially resolved radiation signals is disclosed, the device comprising:

a spatial modulator configured for a spatially resolved imaging of a plurality N of locations onto a detector; and

a computer being configured for controlling said spatial modulator for imaging said plurality N of locations onto said detector by means of an amplitude modulation with one particular frequency sine, however with a phase shifting of 360°/N with respect to each other, and for evaluating signals received by said detector using a Fourier transformation for computing signal differences between said plurality N of locations.

According to another aspect a method for measuring spatially resolved radiation signals is disclosed, the method comprising the steps of:

imaging a plurality of pairs of at least two locations using a spatial modulator in a spatially resolved way onto a detector; and

either modulating the locations of each pair using the same Hadamard sequency, wherein said Hadamard sequency is inverted at one location of a pair with respect to another location of said pair, and computing an intensity difference between said two locations of each pair using a Hadamard transformation; or

amplitude modulating both locations of each pair with the same sinus frequency, however with a phase-shifting of 180° with respect to each other, and by evaluating a signal received by said detector using a Fourier transformation for computing an intensity difference between the locations of each pair of locations.

According to another aspect a method for measuring spatially resolved radiation signals is disclosed, the method comprising the steps of:

amplitude modulating a plurality N of locations using a spatial modulator with the same frequency sin², however with a phase-shifting of 360°/N with respect to each other;

imaging said plurality N of locations onto a detector; and

evaluating signals received by said detector using a Fourier transformation for computing signal differences between said plurality N of locations.

According to the invention a differential measurement of signals is made possible, for instance of the signals of one measurement location (measurement spot) and of a reference location (reference spot). If the measurement is performed at two locations, then the signals of the measuring location are phase-shifted with respect to the signals of the reference location by 180°. Herein a detector based on spatial modulation observes the intensity of the two observation locations. By shifting an intensity difference recorded by the detector at the observation locations into the frequency spectrum of the total signals the intensity difference can be analyzed within the frequency domain and can be directly detected. In this way also at very high absolute signal amplitudes, as well as at intense environmental brightness, a high dynamic can be reached within the resolution of the intensity difference. The necessary measuring range in practice is limited to the difference, not to the deflection of the absolute signals, such as the case in prior art RIfS systems. Basically any number of pairs of measurement locations (spots) can be observed simultaneously.

The invention realizes a detection based on spatially resolved modulation, which also at high radiation intensities allows for a measuring of the smallest optical signal differences between two measuring locations (spots) with high dynamic resolution, and thus improves a multi-spot RIfS method considerably. The invention allows for spatially resolved measurements, in particular intensity measurements within liquids, such as for instance occur with RIfS measurements. Herein also very small intensity differences can be resolved.

Apart from that the invention can also be applied onto other measurement signals, such as onto damping measurements, such absorption measurements in liquids, or within the astronomy, such as the observation of suns and moons, wherein the smallest intensity differences must be resolved in view of high background signals. Also adsorption measurements in the sense of detecting accumulations of particles at a surface, and evaluating a transmissive optical signal are conceivable.

According to the invention by the spatially resolved imaging of the measurement signals into the frequency domain a direct detection of the differential signal is made possible, whereby the dynamic of the measurement is improved considerably with respect to prior art methods.

This is possible on the one hand with the known Hadamard transformation. Herein the two differentially measured locations are modulated with the same Hadamard frequency, wherein the sequence at one of the two locations is inverted. If both locations have the same brightness, then herein the signal parts of the carrier sequency extinguish each other and there remains only the constant part. Thus a difference from zero is measured, since there is no signal part with the sequence searched for. If one of the locations has a different intensity, then also the total signal varies, since it now in addition contains a signal part. By means of a Hadamard transformation from the detected signal there can be computed the intensity difference between the two locations.

Alternatively the intensity difference between the locations can be computed by means of a Fourier transformation from the signal difference of the amplitude-modulated, however phase-shifted signals of the locations with respect to each other using the same frequency. Also herein the signal parts of the same carrier frequency of two locations of the same brightness extinguish each other, and there remains only a constant part. If one of the locations has a different intensity, then also the total signal varies which now in addition has a signal part for which the intensity difference can be computed by means of a Fourier transformation.

According to a further variant N locations are modulated with the same modulation frequency sine, however with a phase-shifting of 360°/N with respect to each other, and the signal difference between the locations is evaluated. The modulation thus is done with the function sin²(ft)=½ (1−cos(2 ft)), so that the signal is on the carrier frequency 2f.

If the intensity at all spots is the same, then the spectral part at the modulation frequency is equal to zero. If one or more of the spots are different from the other spots, then the intensities no longer compensate each other, and then at the carrier frequency 2f a signal amplitude can be measured. In this way a whole sequence of spots can simultaneously monitored, e.g. for carrying out a star monitoring with respect to exo-planets according to the so-called transit method. If the orbit of a planet is located so that from the sight of the earth it directly passes before its star, then the coverings lead to periodic droppings in the brightness thereof. The method according to the invention is particularly suited for such highly precise brightness measurements of the star so that the existence of exo-planets can be more easily shown.

This can be seen as a virtual star-point-measurement (in analogy to rotary current). If at the same time the phase position is monitored, then possibly it can also be determined which one of the spots has changed.

Basically the method according to the invention and the device according to the invention are also suitable for a spatially resolved measurement of absolute radiation signals, in particular light signals, without generating the differential signals of at least two locations.

To this end a plurality of locations is imaged with different frequencies spatially resolved by means of an amplitude modulation onto a detector, and by means of a Fourier transformation the intensity of the radiation signals is computed at the locations. Correspondingly at a device for the spatially resolved measurement of radiation signals a modulator is provided for generating different frequencies, by means of which different locations are imaged amplitude-modulated onto a detector, and by means of a computer the intensities of the radiation signals are computed spatially resolved by means of a Fourier transformation, to which end in particular a discrete Fourier transformation, in particular a fast Fourier transformation (FFT) is used.

If the measurement method according to the invention is used by means of a variant of the Fourier transformation, then the amplitude-modulated signal of the locations are transmitted by means of frequency multiplexing to allow for a simultaneous observation.

According to another aspect of the invention the different frequencies are generated by means of a spatial light modulator (SLM) which preferably is controlled by means of pulse-modulated signals (PWM-signals), wherein the analog frequency signal is obtained by means of low-pass filtering of the electric signal.

SLMs are time discrete, in particular time and value discrete signal generators. They are available as transmissive and reflective liquid crystal displays (LCDs) as well as micro mirror arrays (MMAs), also called digital micro mirror arrays (DMDs). Digital micro mirror arrays allow for a binary modulation of light. DMDs can deviate light for individual pixels into one or a different direction. In practice DMDs are available with a large number of micro mirrors. The complete design is on a carrier substrate upon which memory cells are built up below the mirrors in CMOS technology. These memories can store exactly one bit of information, “on” or “off”. The individual mirrors tilt across their diagonals, wherein the setting force is of electrostatic origin. For instance DMDs with a resolution on the order of 1 Megapixel, or of 1 million micro mirrors, respectively, are available which can be controlled by a connected controller for setting the mirrors simultaneously according to a previously stored information according to a triggering pulse. With DMDs switching speeds of several tenth of kilohertz, and thus also high modulation frequencies, can be reached.

To utilize such binary, digital signal generators for the output of a signal approximated to an analog signal, such as in the form of a sinus oscillation, a digital/analog conversion is necessary, to which end the binary, digital signal generators, or the DMDs, respectively, are preferably driven by means of PWM signals, wherein the analog frequency signal is obtained by means of low-pass filtering. Herein a sampling of a PWM-frequency is performed in particular time intervals. Correspondingly to the sampling value in the respective sampling interval the pulse width in this sampling interval is configured. By means of a subsequent low-pass filter the harmonic components generated by the PWM are suppressed, whereby the signal at the output of the filter corresponds to the desired analog signal, such as a sinus signal. Herein preferably the low-pass filtering is done after detecting the signal in the electrical part, since light signals in the sense of the frequency spectrum physically cannot be low-pass filtered. Thus the low-pass filtering is done within the electric circuitry after the light detector. In this way according to the invention a quasi-analog SLM is generated by a digital SLM, and at the end analog signals are obtained.

According to another aspect of the invention the detected and low-pass filtered signal is transformed into a digital signal, and subsequently the frequencies are computed and the locations are decoded using a discrete Fourier transformation, in particular a fast Fourier transformation (FFT). Thus the spatial information is recovered from the detected time signal by means of the fast Fourier transformation.

According to another aspect of the invention before the detection of the signal an optically spectral resolution of the signal is performed and the spectrally resolved signal is detected wavelength-specifically, and by means of a discrete Fourier transformation the intensity of the locations is computed for each detected optical signal part.

Each of the optically spectral partial signals again is composed of the respective signal part of the different observation locations. The optically spectral partial signals are a superposition of the respective modulated spectral parts at the observation locations. In this way a hyperspectral observation is made possible.

According to another aspect of the invention a plurality of location pairs of observation locations and reference locations are each modulated with the same modulation frequency, and the signal difference between the observation location and the reference location is evaluated.

Herein preferably for performing a zero balancing individual observation locations and/or reference locations can be switched on or off.

Thereby the dynamic range of the measurement can be further improved. In this way in the observation of fields, i.e. areas, which are observed using a group of SLMs, or DMD-pixels respectively, with the same modulation frequency, a precise zero balancing can be performed.

If during the differential measurement die amplitude of the signal is significantly larger than the amplitude of the reference signal, then the number of active micro mirrors for the modulation of the signal field can be lowered. Such an adaptation of course can also be performed with respect to the reference signal field or with respect to both fields. By compensating both fields with respect to the observation locations and the reference locations in this way a very high precision of the zero balancing can be obtained, and the dynamic range can be further improved.

According to another aspect of the invention a frequency multiplexer is provided for the simultaneous transmission of the amplitude-modulated signals of the locations onto the detector.

As previously mentioned, preferably as a modulator a Spatial Light Modulator (SLM), in particular a micro mirror array (DMD), is used which preferably outputs a quasi-analog, amplitude-modulated signal by means of pulse width modulation (PWM). Herein preferably a low-pass filter for the suppression of the harmonic oscillations generated by the PWM is provided, which is preferably arranged after the detector.

According to another aspect the output of the low-pass filter is coupled with the computer by means of an analog/digital converter (ADC) by means of which the intensity information for the locations is provided by means of a discrete Fourier transformation, preferably by means of a fast Fourier transformation (FFT).

According to a first configuration a radiation source is provided for illuminating the SLMs or the DMDs, respectively, wherein the radiation emitted by the SLMs is transmitted to the observation object, and the radiation emitted by the observation object is imaged onto the detector.

According to another aspect of the invention the observation object is illuminated by means of a radiation source, wherein the radiation emitted from the observation object is transmitted to the SLM, or the DMD, respectively, and the radiation emitted from the SLM, or the DMD, respectively, is imaged onto the detector.

This configuration has the advantage that herein the crosstalk between the individual channels is small.

The detector preferably is a photo detector, in particular configured as a photo diode or as a photo multiplier tube (PMT), preferably being configured as a photo detector array.

For a hyper-spectral observation the signals of the locations are transmitted by means of a spectrometer optically spectrally resolved onto the detector array, and the computer is configured for the wavelength-resolved computation of the intensity differences between the locations. Preferably the SLM, or the DMD, respectively, comprises a plurality of channels, and to each measuring signal of a measurement spot a reference signal of a reference spot is assigned.

Herein during a measurement of a plurality of locations with the same frequency individual of the assigned reference signals and/or measuring signals can be turned off or turned on for a zero balancing.

In this way a very precise zero balancing and an increase in the dynamic can be reached.

According to another aspect the detector is followed by an amplifier, in particular a trans-impedance amplifier, which is connected to the computer via a high-pass filter, a low-pass filter and an analog/digital converter ADC.

According to another aspect of the invention means for imaging an observation object onto the DLM or onto the DMD, respectively, and for transmitting the signals emitted by the SLM or by the DMD, respectively, onto the detector, there is further provided a gauging camera for observing the observation object and for selecting observation locations that are transmitted onto the detector.

According to another aspect of the invention a high-pass filtering is performed, preferably after an amplification of the signal received by the detector.

In this way the constant parts can be reduced.

According to another aspect of the invention an offset signal is added to the signal received by the detector for suppressing the constant parts.

Thereby the sensitivity can be significantly increased.

The offset signal for instance can be derived from the low-pass filtered and amplified signal.

It will be understood that the afore-mentioned features and the features to be explained hereinafter cannot only be used in the respectively given combination but also in different combinations, or independently, without leaving the scope of the current invention.

### BRIEF DESCRIPTION OF THE DRAWINGS

Further features and advantages of the invention can be taken from the subsequent description of preferred embodiments with reference to the drawings. In the drawings show:

FIG. 1 is a general schematic representation of a first configuration of a device according to the invention for the spatially resolved measurement of radiation signals;

FIG. 2 is a general schematic representation of a modified configuration of the device according to FIG. 1;

FIG. 3 is a general schematic representation of a further modification of the device according to FIG. 1;

FIG. 4 illustrates the basic principle of the measuring method including the selection of observation locations and a frequency modulator for different frequencies;

FIG. 5 illustrates the basic principle of the measuring method including different amplitude-modulated frequencies which are assigned to the individual observation locations, further the analog total signal and the assigned spectrum, after a Fourier transformation;

FIG. 6 is a waveform diagram illustrating the principle of generating a PWM signal for the modulation of a sinus-shaped analog signal;

FIG. 7 is a general schematic representation of the device of FIG. 1 including additional explanations with respect to the measuring method;

FIGS. 8A) and B) are schematic representations for explaining the principle of the differential measurement, wherein in FIG. 8A) the two initial signals to be measured in the form of sinusoidal-shaped signals are shown that are phase-shifted with respect to each other by 180°, wherein FIG. 8B) shows the principle circuit diagram for the summation;

FIG. 9 is a general schematic representation of a further modification of the device according to the invention according to a test design used in practice;

FIG. 10 illustrates a principle representation of a spectral resolution of the measuring signal and the analysis using a line spectrometer allowing a hyper-spectral analysis;

FIGS. 11A) and B) illustrate a zero balancing in the case of observation of fields using a plurality of areas that are observed with the same modulation frequency using a group of micro mirrors, wherein in FIG. 11A) measuring fields with a plurality of active observation locations are shown, and wherein in FIG. 11B) the respective reference fields with an adapted number of active observation locations are shown; and

FIG. 12 is a circuit diagram for compensation of the constant part at the input of the trans-impedance amplifier.

### DETAILED DESCRIPTION OF THE PREFERRED EMBODIMENTS

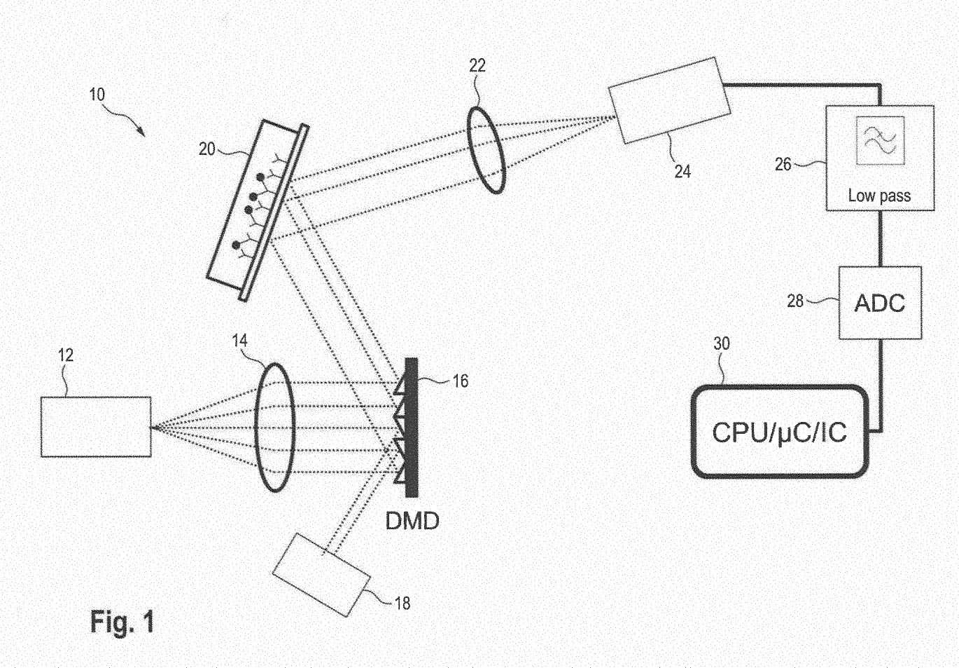

FIG. 1 shows a first possible design of a device according to the invention for the spatially resolved measurement of light signals that is particularly suited for reflectometric interference spectroscopy (RIfS).

The device depicted in total with 10 comprises a light source 12 the light of which is directed plane-parallel via a lens 14 onto a spatial modulator 16 being configured as a digital micro mirror array (DMD). Herein exemplarily the DMD is shown with five micro mirrors, from which three are activated. The non-activated micro mirrors deflect the incoming light laterally towards a black absorber 18. The activated micro mirrors direct the light onto the assigned observation object 20. The observation object 20 for instance may be an object to be analyzed by means of RIfS, wherein particular biomolecules to be analyzed are adsorbed at the surface, such as depicted here exemplarily. This is a multi-layer system, for instance consisting of a silicon dioxide layer and a high refractive tantalum pentoxide layer and a further silicon dioxide layer which can be chemically modified. At each phase interface partial rays of the light are reflected and are transmitted refracted. The reflected partial rays superimpose to an interference spectrum which shall be detected. By means of chemical modification the uppermost SiO₂ layer can be modified so that it can interact with the target molecules. This interaction causes a modification of the physical layer thickness and of the refractive index of this layer. The product of both is defined as the optical layer thickness: n·d. The modification of the optical layer thickness leads to a modulation of the interference spectrum. From this the layer thickness can be determined. If the modification of the interference spectrum is observed over time then it is possible to observe the adsorption at interfaces, the adsorption in thin layers, or the association of binding partners to the target molecules.

In the represented case the observation object 20 merely is a surface that reflects the irradiated light coming from the micro mirrors of DMD with spatially varying intensity. The reflected or emitted light, respectively, reaches a subsequent lens 22 by means of which it is focused onto a detector 24. The detector 24 is for instance a photo detector. The photo detector converts the incoming light signal into an electrical signal. This is fed to a low-pass 26. Thereafter the signal is converted into a digital signal using an analog/digital converter ADC 28, and is finally fed to a computer 30.

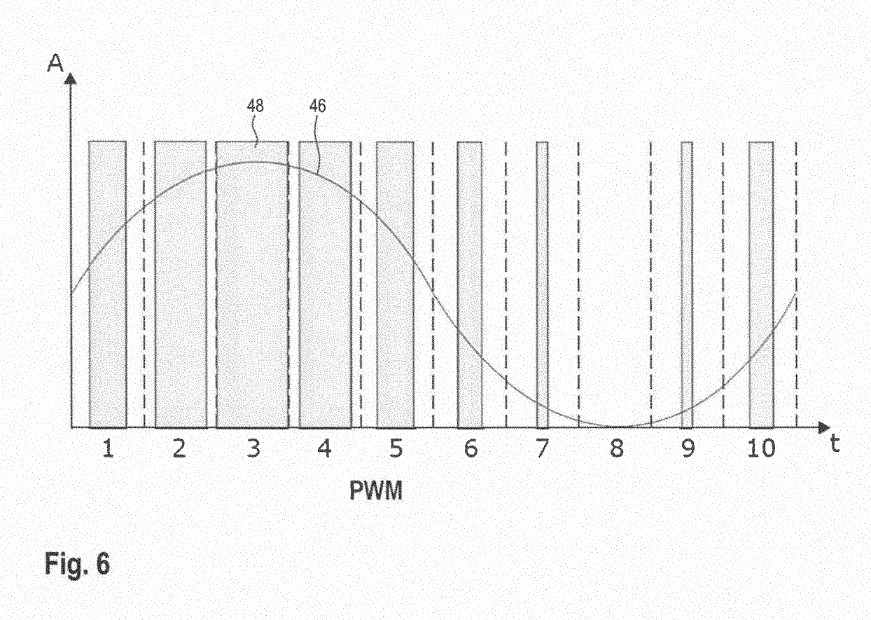

By means of the DMDs 16 the incoming light is modulated with a different frequency for each observation location that is exposed by one of the micro mirrors. Since the DMD is a binary, digital signal generator (SLM), the individual micro mirrors of which can only be tilted between two positions (1 bit) for approximating a sinus signal, a PWM modulation is performed, whereby the sinus-shaped analog signal is obtained by a subsequent low-pass filtering as will be shown in more detail subsequently with respect to FIG. 6.

The DMD 16 by means of the PWM modulation generates different frequencies for each micro mirror. The signals emitted by the DMD 16 impinge onto the observation object 20 and lead to an amplitude modulation of the impinging light rays due to the different intensities at the individual spots of the observation object 20. The light rays emitted by the observation object 20 finally are directed onto the detector 24 focused by the subsequent lens 22. The low-pass filter for suppressing the harmonic oscillations that are generated by the PWM modulation of the DMDs is arranged after the detector 24, since a low-pass filtering of light signals physically is not possible. At the output of the low-pass filter now an analog sum signal is available that was generated by frequency multiplexing from the individual signals. The spatial information herein is represented within the carrier frequency parts.

After conversion into a digital signal by means of the ADC 28 in the computer 30 a fast Fourier transformation FFT is performed for computing the frequency spectrum of the superimposed signal from the digital sensor signal.

It will be understood that the detector 24 must operate in the in the linear range to ensure a proportionality between the computed frequency spectrum and the analog intensity signal of the individual observation locations.

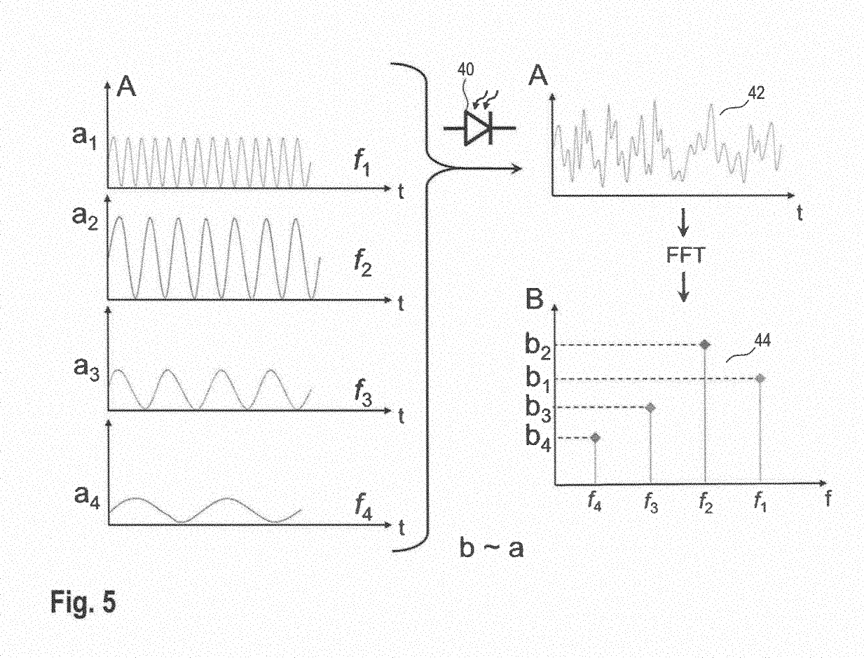

From the computed intensities of the different frequencies then the spatial information can be recovered, as will be subsequently explained in more detail with reference to FIG. 5.

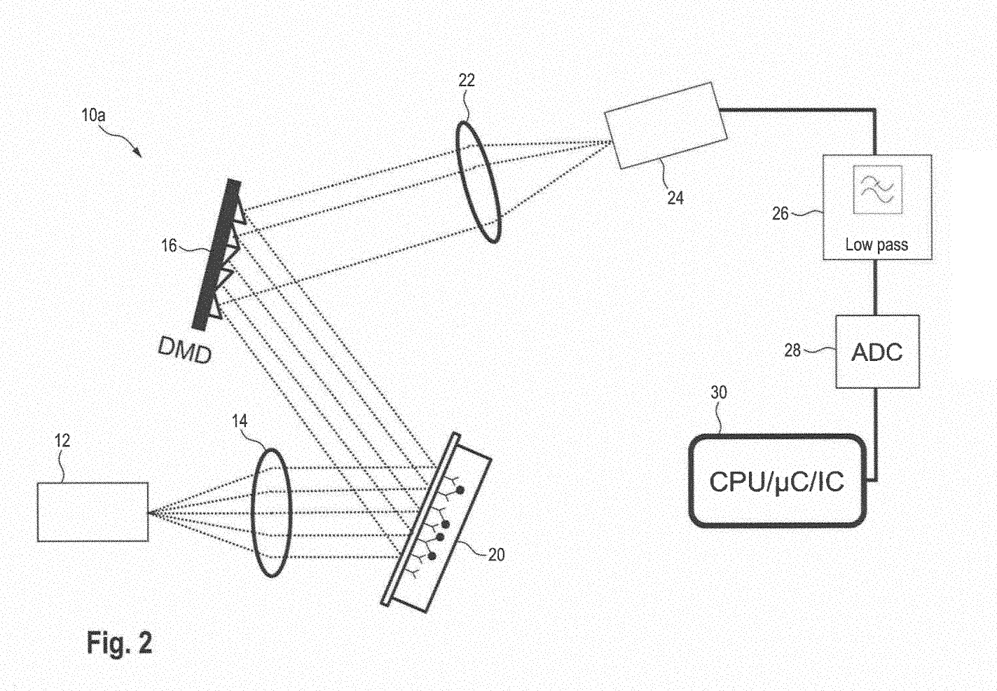

FIG. 2 shows a modification of the device according to FIG. 1, designated in total with 10a. To this end and also within the subsequent figures, equivalent reference numerals are used for equivalent parts.

Herein the observation object 20 is directly irradiated by means of the light source 12 using the assigned lens 14. The light radiation emitted by the observation object 20 then is directed onto the modulator, the micro mirror array DMD 16. At the DMD 16 again the PWM modulation is performed, as explained above. The subsequent design is the same as the one described with reference to FIG. 1. Thus the light reflected from the activated micro mirrors reaches the detector 24 by means of the subsequent lens 22, wherein the output signal of the detector is fed by means of the low-pass 26 and the subsequent ADC 28 in digitized form to the computer 30 for analysis.

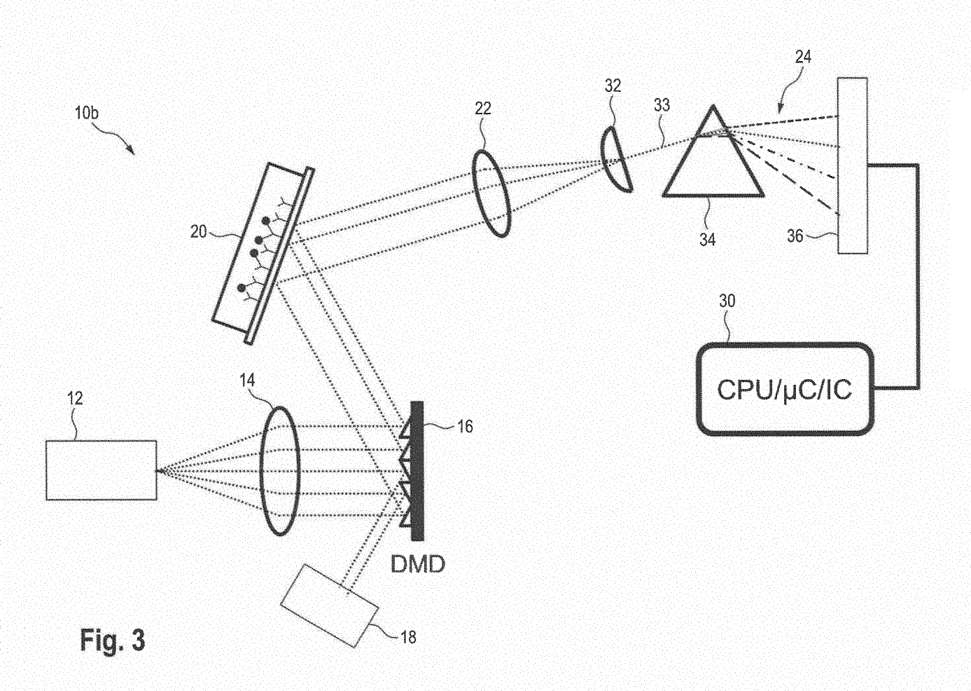

FIG. 3 shows a further modification of the device according to FIG. 1 which is depicted in total with 10b.

The detector 24 herein is not a photo detector, but consists of a prism 34 for the spectral analysis and a subsequent line spectrometer 36 including a photo detector array. The light emitted by the observation object 20 is focused via the lens 22 and a further lens 32 to a light array that impinges onto the prism 34 and is separated into its spectral parts, as shown here exemplarily by means of four lines. Depending on the number of the subsequently arranged detector elements a different amount of spectral parts can be analyzed. For instance four detector elements can be used for distinguishing four optical spectral parts. Each of this optical spectral partial signal again is comprised of the respective signal parts of the different observation locations. In this way using the subsequent FFT-analysis (one FFT for each optical spectral part) within the computer 30 a hy-per-spectral analysis is made possible (the low-pass 26 and the subsequent ADC 28 in FIG. 3 were not shown for ease of representation).

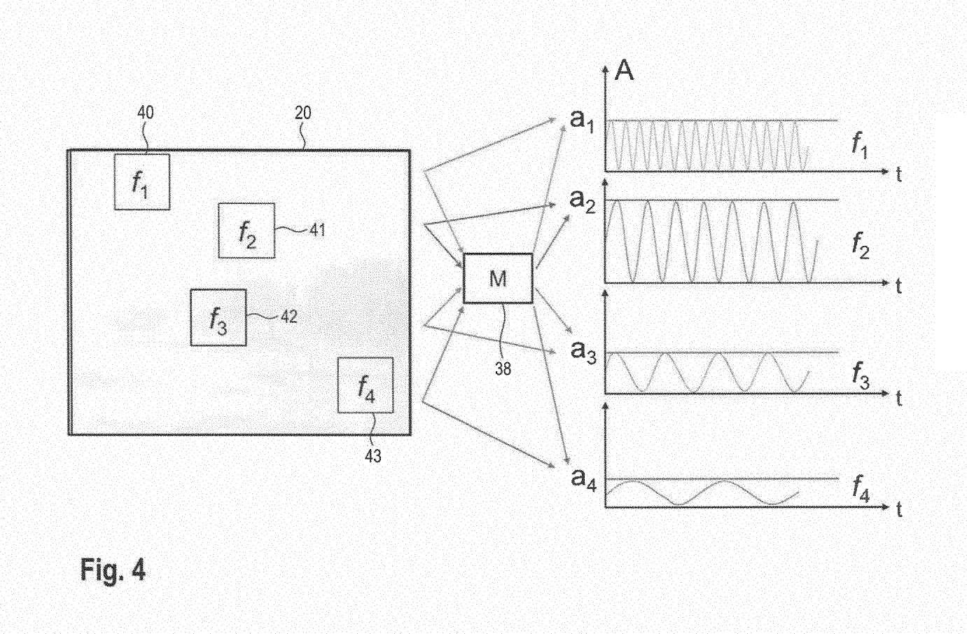

The measuring principle again is explained subsequently with reference to FIGS. 4 to 8.

FIG. 4 shows an observation object 20 with four observation locations (spots) 40, 41, 42, 43 which each represent a particular cutout from the observation object 20. To each observation location (spot) a particular frequency f₁, f₂, f₃, f₄ is assigned which is generated by a modulator 38. Thus four different frequencies f₁, f₂, f₃, f₄ result, that are assigned to the individual spots 40, 41, 42, 43, and that are amplitude-modulated depending on the intensity of the spots 40, 41, 42, 43. Thus the individual partial signals are generated that are shown in the right part of FIG. 4. The amplitude-modulated partial signals with the intensities a₁, a₂, a₃, a₄ according to FIG. 5 are superimposed to the sum signal, so that there results the sum signal 42 in the right upper half of FIG. 5. The super-position simply is performed by adding the individual signals by means of the lens 22, which is shown in FIG. 5 separately as a frequency multiplexer 40.

From the sum signal 42 after the subsequent digitizing again the frequency information with the carrier frequencies f₁, f₂, f₃, f₄ is computed using a fast Fourier transformation FFT within the computer 30, wherein the assigned amplitudes b₁, b₂, b₃, b₄ represent the intensity information of the observation locations 40, 41, 42, 43. In case the linearity of the detector is ensured, the amplitude b₁, b₂, b₃, b₄ in the frequency spectrum is proportional to the brightness a₁, a₂, a₃, a₄ of the observed spots 40, 41, 42, 43. This is inherently present by the connection with the Fourier transformation or by the definition of the frequency spectrum, respectively.

With reference to FIG. 6 now the PWM modulation of the DMDs 16 for the generation of different frequencies is explained in more detail.

FIG. 6 shows a line 46 of the desired sinus signal that shall be generated by the PWM. If the signal 46 to be generated is sampled in particular time intervals using the so-called PWM-frequency f_{PWM}, then in the individual sampling intervals that are shown on the time axis by equally spaced dashed lines, differently broad pulses result. Sampling intervals with a high signal amplitude obtain a broad pulse (see interval 3, 100% pulse width), sampling intervals with smaller signal amplitude obtain a smaller pulse (see interval 8, 0% pulse width). Herein for the PWM frequency there is f_{PWM}>2 fₘₐₓ, wherein fₘₐₓ is the largest frequency occurring in the analog signal (Nyquist condition). With the DMDs used fₘₐₓ is the maximum switching frequency of the micro mirrors.

The harmonic oscillations generated by the PWM are suppressed by a subsequent low-pass filter, whereby the signal at the output of the filter corresponds to the desired analog signal 46.

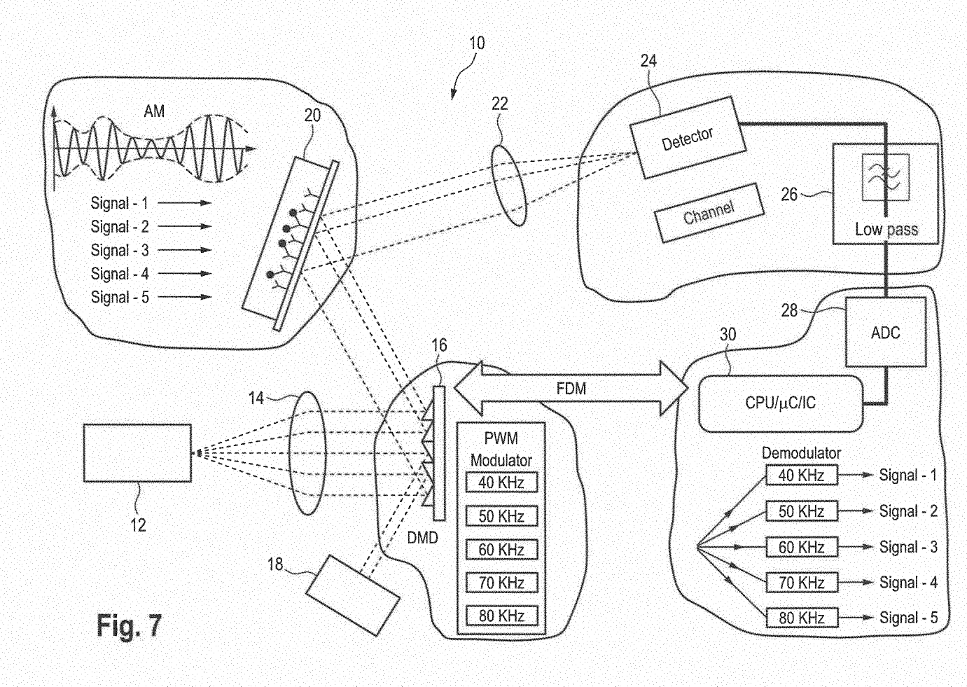

FIG. 7 again shows the device 10 according to FIG. 1 with additionally shown information to more clearly explain the relationships of the measuring method.

The DMD 16 is irradiated using a light source 12 by means of a lens 14. The DMD 16 is driven by means of PWM modulation so that for each micro mirror an individual frequency is modulated. Herein exemplarily five micro mirrors are shown to which there are assigned the frequencies 40 kHz, 50 kHz, 60 kHz, 70 kHz, and 80 kHz. The individual micro mirrors modulate different locations of the observation object with different frequencies, due to the PWM modulation of the DMDs. The different intensities at the different spots of the observation object 20 lead to an amplitude modulation AM of the carrier frequency signals irradiated by the DMD 16.

The signals emitted by the observation object are collected by means of the lens 22 (frequency multiplexing, Frequency Division Multiplexing—FDM) and are directed onto the detector 24, which may be a single photo detector. The detector converts the incoming light sum signal into an electrical sum signal. This subsequently reaches the low-pass 26 and then the ADC 28 for converting into a digital signal. The digital signal is fed to the computer 30 for analysis. Within the computer 30 the sum signal again is de-modulated using the FFT to recover the individual initial frequencies 40 kHz, 50 kHz, 60 kHz, 70 kHz, 80 kHz and to determine the assigned amplitudes, such as shown in FIG. 5.

According to the invention now preferably a pair of observation locations is modulated with the same frequency, and therefrom a differential signal is obtained.

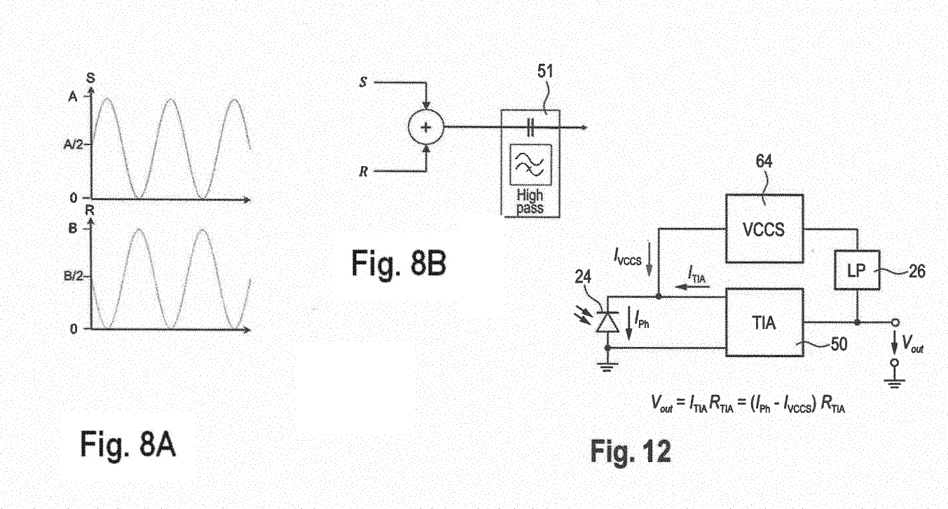

FIG. 8 exemplarily in FIG. 8A) shows in the upper part a sinus-shaped measuring signal S with the amplitude A, and in the lower part the assigned sinus signal R of a reference location with the amplitude B that is face-shifted with respect to the measuring signal S by 180°. According to FIG. 8B) the two signals S and R are added and subsequently fed through a high-pass filter 51 for filtering out the constant part.

To the term constant part: If there are two observation points with the brightnesses A0 and B0, then these are modulated with the same frequency and with a phase-shift of 180° (Fourier transformation), then:

signal A=A0*½*(1+sin(wt)),

signal B=B0*½*(1−sin(wt)).

If A0=B0, then the frequency part of the modulation frequency is extinguished. There remains only the total signal G which only consists of the constant part:

G=A+B=A0.

A signal part at the modulation frequency only results, if A0 is not equal to B0. But still then the remaining constant part must be suppressed (which at small differences is still relatively large). This is done by the high-pass filter.

Thus preferably at the measurement a signal spot and a reference spot are modulated with the same frequency, for allowing during the subsequent sum formation of the signals, that are phase-shifted with respect to each other, that there is determined only the intensity difference between the signal spot and reference spot.

This method is particularly advantageous for the RIfS analysis, since herein the smallest variations in the reflected radiation spectrum must be detected in view of simultaneously high background intensity. During the RIfS analysis the actual measuring signal only represents a fraction of the detected signal. If the detector has an insufficient dynamic resolution, then according to prior art RIfS measuring methods the measuring signal cannot be resolved from the total signal.

The differential measurement according to the invention leads to a considerable dynamic improvement and thus to a major advantage when compared to prior art RIfS measurement methods.

Alternatively it is conceivable to perform a modulation with an sin²-function instead of a sinus modulation. In this case N observation points (spots) are modulated with the same frequency, however with a phase-shifting of 360°/N with respect to each other. If the intensity is the same at all spots, then the spectral part at the modulation frequency 2f is equal to zero. If one or more of the spots are different from the other spots, then the intensities do not balance each other anymore, and at the carrier frequency 2f a signal amplitude can be measured. In this way a total sequence of spots can be monitored simultaneously, for instance for carrying out a star monitoring of exo-planets using the so-called transit method. This can be seen as a virtual star-point measurement (in analogy to rotary current). If simultaneously the phase position is monitored, then possibly also it can be determined which spot has modified.

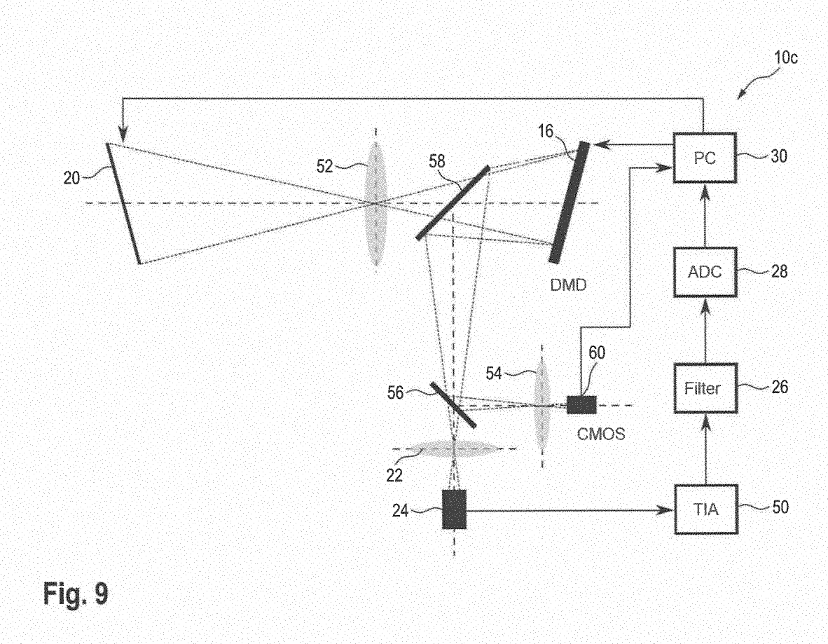

In FIG. 9 an experimental set-up is shown that was used for verification of the presented measurement method. In FIG. 9 a measurement device according to the invention is depicted in total with numeral 10c.

Herein in addition to the set-up according to FIG. 2 there is provided a gauging camera 60 configured as a CMOS camera. To allow the integration of the gauging camera 60 into the radiation path, the device 10c apart from the observation object 20 and the DMD 16 comprises two semi-transmissive mirrors 56, 58 and three lenses 22, 52, 54. A computer 30 controls the DMD 16 and the observation object 20 that may consist of a LCD simulation field.

The computer 30 receives the image signal of the gauging camera 60. A trans-impedance amplifier (TIA) 50 converts the signal of the detector 24 into a voltage signal and amplifies it. The output of the trans-impedance amplifier 50 via a filter 26 is connected to an analog/digital converter ADC 28, the output of which is connected to the computer 30. Starting from the observation object 20 in the left upper corner of the representation light reaches through the lens 52 that generates a sharp image onto the DMD 16 by means of the semi-transmissive mirror 58. Due to the tilted arrangement between the observation object and the DMD 16 the so-called Scheimpflug condition must be fulfilled: A sharp representation of a tilted plane is obtained, if the image plane, the lens and the object plane intersect at the same line.

The DMD 16 modulates the respectively assigned carrier frequency by means of PWM onto the respective measurement locations (spots). This means an “on”-state, if the DMD 16 directly reflects the light into the direction of the semi-transmissive mirror 58, and the “off”-state means that the micro mirror of the DMD 16 deviates the light upwardly out of the system. The amplitude-modulated light thus impinges back onto the semi-transmissive mirror 58, which deflects it downwardly to the second semi-transmissive mirror 56. Again, half of the light from here reaches the lens 22 and is focused onto the detector 24. The other half of the light reaches the gauging camera 60 by means of the lens 54, where a sharp imaging is generated. Also herein the Scheimpflug condition is kept.

The gauging camera 60 is only an optional addition and simplifies the gauging and the control of the system. The computer takes over the control of the DMD 16 and receives the image of the gauging camera 60 as well as the signal from the detector 24 which initially is amplified using the trans-impedance amplifier TIA 50, protrudes through the filter 26 and is finally converted into a digital signal by means of the ADC 28. As an observation object 20 an LCD display is used which is driven by the computer 30.

As the DMD 16 there was utilized a DMD from the company Texas Instruments according to the designation DLP7000 DLP® 0.7 XA 2× LVDS Type A.

In the shown case only a single photo diode is provided as the detector 24, namely a silicon photo diode of the company Thorlabs, of the type SM05PD1A with a wavelength range of 350 to 1100 nm, an active sensor surface of 13 mm2 and a maximum sensitivity of 0.37 A/W at 980 nm.

The trans-impedance amplifier 50 DLPCA-200 of the company FEMTO offers adjustable amplification factors of 1×10³ up to 1×10¹¹V/A at a maximum bandwidth of 500 kHz. Initially a high-pass filter is arranged after the amplifier, then a second amplifier follows and finally an optional low-pass (depending from the selected observation frequency band). The high-pass filter serves for suppressing constant parts.

The filter 26 comprises a filter bank of in total three filter levels with a low-pass filter for suppressing high-frequent interfering signals, a high-pass filter for damping constant parts and very small frequencies, and a notch-filter, in particular for suppressing disturbant net frequencies (50 Hz and 60 Hz).

The ADC 28 is a RedPitaya board with a processor dual core ARM Cortex A9, a sampling rate of 125 MHz and a resolution of 14 bit.

Using the device 10c it was shown that the measuring arrangement is suitable for a RIfS measurement using a micro fluid channel from the RIfS range as an observation source. To allow an investigation of any kind of measurement objects independently thereof, a LCD monitor was utilized as a flexible simulation field.

For the RIfS measurement a micro fluid channel of separate channels each having an input and a common output was used. To this end a pump sucks on two solutions to be compared from two containers and pumps it through elastic tubes into the two fluid channels. Using the measurement device 10c the brightnesses of the respective reflective light was measured within the fluid channels.

Using the device 10c the overall operativeness was confirmed, and first measurements were performed using an LCD-monitor. Also the measurements with a RIfS fluid channel were successful.

Frequency bands in the range of 15 Hz to 4000 Hz were investigated using PWM signals. With the help of the LCD simulation field a resolution of 13 bit was verified.

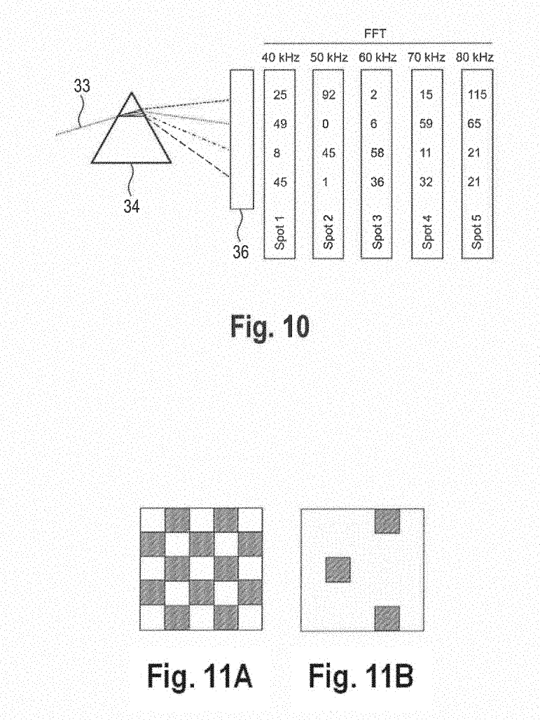

Now with respect to FIG. 10 a further option is briefly explained for performing a hyper-spectral analysis.

To this end the detector 24 is replaced by a dispersive line spectrometer 36 according to FIG. 10 (see also FIG. 3). In FIG. 10 the dotted line 33 shows the impinging light bundled onto the detector. The prism 34 splits this light into its optical spectral parts. The radiation spectrum now impinges onto the photo detector array 36 with four (shown here exemplarily) elements and thus allows the distinction of four optical spectral parts of the radiation spectrum. Each of this optical spectral partial signal again is composed of the respective signal parts of the different observation locations (spot 1 to spot 5). The optically spectral partial signals are a superposition of the respective modulated spectral parts at the observation locations. The information with respect to the assignment to the observation locations is within the frequency spectrum (40 kHz, 50 kHz, 60 kHz, 70 kHz, 80 kHz) of the optically spectral partial signals. By means of the FFT the information with respect to the observation locations within the frequency spectrum can be computed for each of the spectral parts. In this way a hyper-spectral camera can be built.

According to a further feature of the invention, for obtaining a high dynamic range, fields can be observed, i.e. areas that are observed by means of a group of micro mirrors, using the same modulation frequency. Then a zero balancing can be performed. FIG. 11 shows this zero balancing exemplarily for a differential measurement.

FIG. 11A) for a differential measurement shows the signal spot with 25 observations pixels, and FIG. 11B) shows the assigned reference spot with three activated observation pixels. If the amplitude of the signal is considerably higher than the respective one of the reference signal, then the amount of active micro mirrors is decreased for modulating the signal field. Such an adaptation naturally also can be performed on the reference signal field or on both fields. By adjusting both fields a very high precision of the zero balancing can be reached. In addition the dynamic range is further increased.

In FIG. 12 a further possibility for increasing the sensitivity is shown by suppressing the constant parts. In the device according to FIG. 9 the filter 26 comprises a high-pass filter for suppressing the constant parts (apart from the switchable low-pass filter, depending on the frequency).

By an additional circuitry according to FIG. 12 the constant part can already be reduced before the trans-impedance amplifier 50. To this end an additional current source can be connected to the junction of the trans-impedance amplifier 50 and the detector 24, and this can be adjusted/controlled in such a way that a part of the photo current flows into the source instead into the trans-impedance amplifier 50. In this way before the trans-impedance amplifier 50 an offset can be implemented.

The offset for the additional current source at the junction of the trans-impedance amplifier 50 and the detector 24 allows to reduce the signal part of the basic brightness/constant parts already before the trans-impedance amplifier 50. In FIG. 12 VCCS indicates a voltage-controlled current source (Voltage Controlled Current Source) 64.

The output voltage Vₒᵤₜ at the output of the trans-impedance amplifier 50 then is:

Vₒᵤₜ=I_{TIA}R_{TIA}=(I_{D}−I_{VCCS})R_{TIA},

wherein R_{TIA} is the amplification resistance (feedback resistance) of the trans-impedance amplifier 50, I_{D} is the detector current, I_{TIA} is the current of the trans-impedance amplifier 50, and I_{VCCS} is the current of the VCCS 64. The low-pass 26 and the VCCS 64 form an active control loop.

The range of the trans-impedance amplifier 50 in this way can be better used. The overall method then may comprise even smaller signals in view of the basic brightness/constant part.

However the constant part impinging onto the detector 24 cannot be reduced.

With the same physical set-up according to FIGS. 1 to 3 or FIG. 9 a differential measurement also can be performed using a Hadamard transformation instead of the Fourier transformation. In addition also herein the utilization of a high-pass and/or an implementing of a current offset before the trans-impedance amplifier would be advantageous for suppressing the constant parts.

To this end the two differentially measured locations are modulated with the same Hadamard frequency, wherein the sequence is inverted at the two locations. If both locations have the same brightness, then the signal parts on the carrier sequency extinguish each other thereby (in analogy to the differential measurement on a carrier frequency using a Fourier transformation), and also here only the constant part remains.

Basically also different digital modulation methods for realizing the differential measurement would be possible.

What is claimed is:

1. A device for measuring spatially resolved radiation signals, comprising:
a spatial modulator configured for a spatially resolved imaging of a plurality of pairs of locations onto a detector, said detector being arranged for receiving a signal from said imaging of said plurality of pairs of locations;
a computer configured either for controlling said spatial modulator for imaging each pair of locations onto said detector by means of the same Hadamard sequency, wherein said Hadamard sequency is inverted at one location of said pair with respect to another location of said pair, and a signal received by said detector is evaluated by means of a Hadamard transformation for computing an intensity difference between said pair of locations, or for controlling said spatial modulator for imaging each pair of locations onto said detector by means of an amplitude modulating of both locations of a pair with the same frequency, however with a phase-shifting of 180°, and is configured for evaluating a signal received by said detector for computing an intensity difference between said locations of said pair using a Fourier transformation.

2. A device for measuring spatially resolved radiation signals, comprising:
a spatial modulator configured for a spatially resolved imaging of a plurality N of locations onto a detector; and
a computer configured for controlling said spatial modulator for imaging said plurality N of locations onto said detector by means of an amplitude modulation with one particular frequency sine, however with a phase shifting of 360°/N with respect to each other, and for evaluating signals received by said detector using a Fourier transformation for computing signal differences between said plurality N of locations.

3. The device of claim 1, further comprising a frequency multiplexer for transmitting said amplitude-modulated signals of said pairs of locations onto said detector.

4. The device of claim 1, wherein said modulator is configured as a spatial light modulator (SLM).

5. The device of claim 4, wherein said spatial light modulator (SLM) is configured as a micro-mirror array (DMD).

6. The device of claim 5, wherein said SLM is arranged for receiving light emitted by a light source, and wherein said computer is configured for pulse width modulating (PWM) the light impinging onto said SLM.

7. The device of claim 6, further comprising a low-pass filter for suppressing harmonic oscillations generated by said PWM and for generating an analog frequency signal.

8. The device of claim 7, wherein said low-pass filter is arranged after said detector.

9. The device of claim 8, wherein an output of said low-pass filter is coupled to said computer via an analog/digital converter (ADC).

10. The device of claim 1, further comprising an amplifier for amplifying signals received by said detector, and a high-pass filter, said high-pass filter being provided after said amplifier.

11. The device of claim 1, further comprising a light source being arranged for illuminating said spatial modulator, wherein said spatial modulator is arranged for emitting light and for transmitting said light to an observation object, and wherein said detector is arranged for receiving light emitted by said observation object being imaged onto said detector.

12. The device of claim 11, wherein said spatial modulator is configured as a spatial light modulator (SLM).

13. The device of claim 1, wherein said detector is configured as a photo-detector array.

14. The device of claim 1, further comprising a spectrometer being arranged for transmitting signals of said pairs of locations wavelength-resolved onto said detector, and wherein said computer is configured for a wavelength-resolved computation of said intensity differences between said pairs of locations.

15. The device of claim 1, wherein said spatial modulator comprises a plurality of channels, and wherein said computer is configured for assigning a reference signal of a reference location to each detected signal of a location.

16. The device of claim 1, further comprising an amplifier for amplifying signals received by said detector, and further comprising an offset current source for suppressing a constant part, said offset current source is arranged between an output of said detector and an input of said amplifier.

17. The device of claim 2, further comprising a frequency multiplexer for transmitting said amplitude-modulated signals of said N locations onto said detector.

18. A measuring method for a spatially resolved measurement of radiation signals, comprising the steps of:
imaging a plurality of pairs of at least two locations using a spatial modulator in a spatially resolved way onto a detector; and
either modulating the locations of each pair using the same Hadamard sequency, wherein said Hadamard sequency is inverted at one location of a pair with respect to another location of said pair, and computing an intensity difference between said two locations of each pair using a Hadamard transformation; or
amplitude modulating both locations of each pair with the same sinus frequency, however with a phase-shifting of 180° with respect to each other, and by evaluating a signal received by said detector using a Fourier transformation for computing an intensity difference between the locations of each pair of locations.

19. The method of claim 18, wherein a signal field with a plurality of observation locations and a reference field with a plurality of reference locations are evaluated, and wherein for performing a zero balancing during a measurement of a plurality of locations with the same frequency, there are switched on or off at least individual observation locations or individual reference locations within said signal field or within said reference field.

20. A measuring method for a spatially resolved measurement of radiation signals, comprising the steps of:
amplitude modulating a plurality N of locations using a spatial modulator with the same frequency sine, however with a phase-shifting of 360°/N with respect to each other;
imaging said plurality N of locations onto a detector; and
evaluating signals received by said detector using a Fourier transformation for computing signal differences between said plurality N of locations.
